(19) United States
(12) Patent Application Publication
(10) Pub. No.: US 2006/0016940 A1
(43) Pub. Date: Jan. 26, 2006

(54) Apparatus and method for directing an instrument

(76) Inventor: Scott E. Morgan, Saint Paul, MN (US)

Correspondence Address: KONDZELLA AND CYR, PONDVIEW PLAZA, SUITE 114, 5850 OPUS PARKWAY, MINNETONKA, MN, 55343, US

(21) Appl. No.: 10/895,770

(22) Filed: Jul. 21, 2004

(51) Int. Cl. A47F 5/00

(52) U.S. Cl. 248/122.1

(57) ABSTRACT

A mounting apparatus and method for directing an instrument are disclosed. The apparatus has at least a first support which has an arched surface. The first support is hinged to a vehicle to move about a first axis. An instrument mount is secured to the first arched surface of the first support to be positionable at a plurality of points along the arch. A second support may also be provided and is hinged to the vehicle to move about a second axis. The instrument mount may also be secured to the second arched surface of the second support to be positionable at a plurality of points along the second arched surface. The positioning of the instrument mount along the one or more arches directs an instrument secured to the mount.

### BACKGROUND OF THE INVENTION

1. Field of the Invention

The present invention relates generally to directing instruments at targets and, more particularly, to directing instruments mounted on vehicles toward moving or stationary targets on the ground and in the air.

2. Description of the Related Art

A variety of instruments can be mounted to aircraft and other vehicles to send and/or receive signals or images. In the areas of reconnaissance, tracking and surveying, the instruments are typically mounted to aircraft. The instruments are generally directed toward the ground and are configured to receive electromagnetic radiation to produce images, still or moving, of the underlying terrain or of targets on the ground. In some applications, the instruments may be configured to send and/or receive alternative forms of energy or signals.

To permit the instrument to be directed relative to the vehicle, the instruments are typically movably mounted to the vehicle. The instrument may be directed at any target within its range of movement. Some applications can require that the instrument tracks a moving or stationary target on the ground or in the air. In other applications, the instrument may be required to continuously monitor a particular location as the vehicle on which the instrument is mounted moves over or by the location. Still other applications can require that the instrument is directed across a large cross section of terrain as the vehicle moves forward such as by sweeping side to side or in other broadening coverage patterns.

The mounting structures for many instruments commonly include gimbals and gimbal-like systems to permit the controlled movement of the instruments. These mounting structures are configured to secure the instrument and to direct an aperture/sensor/emitter of the mounted instrument. In many cases, instruments mounted to gimbals and gimbal-like systems attempt to substantially balance the mass of the instrument about each axis of rotation. This results in a significant portion of the instrument extending beyond the axis of rotation. Typically, such positioning of such instruments will swing the end of the instrument to be directed at a target in a wide arch outside the center of the gimbals axis of rotation. This arch creates the need for many prior instruments to extend outside of a vehicles body or fuselage so that the instrument can maintain a wide range of movement to track targets.

With some mounting systems, the base of instrument is hingedly attached to the vehicle to swing in an arch of between 0 and 90 degrees. This swinging permits the azimuth to be changed as a target is tracked. Such mounting systems also rotate up to 360 degrees in the horizontal plane. This combination of movements allows the directed end of instrument to move about at least a portion of a hemisphere and provides the instrument with a wide range of movement to direct the instrument at a target. However, these systems and other systems can present some problems in their application.

One problem is the result of the rotation of an instrument relative to the vehicle to which it is mounted. This rotation can twist and torque the cables that connect the instrument to other equipment on the vehicle. This twisting and torquing can increase fatigue and reduce the useful life of the cables. Accordingly, relatively complex rotatable interconnects are typically used to connect of the instrument to other systems in the vehicle. The rotatable interconnects typically increase costs and can create reliability and maintenance issues.

Another problem relates to the control of mounting systems. In certain positions, the control systems for some mounting systems can be subject to gimbal lock. This phenomenon may occur when the instrument is directed along the vertical axis or gimbal pole. With some control systems, this position can induce a singularity error in the control algorithm. In essence, the control system does not know whether to rotate the instrument or change the azimuth to continue directing the instrument. This can lock up the computer and freeze the instrument which prevents further movement of the instrument until the system is reset. Of course, it is not desirable to have an instrument freeze or lock up during an operation.

Further, a semi-circular window or an external turret is necessary to protect the instrument as the aperture swings about its arch of rotation. These structures can be necessary to permit the movement of the aperture of the instrument through its desired range of movement while protecting the instruments from the damaging forces of wind and debris. The windows and turrets commonly extend from the structure of an aircraft or other vehicle. The turrets typically move in conjunction with aspects of the instrument relative to the aircraft. The aperture of the instrument typically has a constant position relative to at least a portion of the turret. The semi-circular windows typically remain stationary relative to the aircraft as the instrument moves relative to the aircraft. The semi-circular windows are substantially transparent to the signal or image which is to be sent or received through them by the instrument. The instrument typically is directed such that its directed end moves about the concave inner surface of the window to track a target through the window. The distance from the interior surface of the window typically remains substantially constant. The constant distance maintains a relatively constant curvature through which the instrument may transmit or receive signals. The relatively constant distance and curvature present a relatively constant level of distortion which can be compensated for by the instrument or by manipulation of the instrument's output data.

The windows and turrets are frequently referred to as “warts” or “blisters” due to the structural anomaly that they present on the fuselage of the aircraft or other vehicles. These structures can produce anomalies in the fluid flow about the vehicle and reflect radar which increases the visibility of the vehicle to enemy radar. On aircraft, these anomalies in fluid flow can substantially increase the aerodynamic drag on the aircraft. This increased drag reduces an aircrafts top speed, increases fuel consumption, creates noise, and alters the aircrafts performance and flight characteristics. In some cases, the anomalies can result in damaging vibration which increases fatigue and maintenance on the aircraft. Accordingly, some aircraft are fitted with fairings around the external housings to smooth airflow. However, these fairings are large and expensive and can limit the range of positions at which the instrument may effectively transmit or receive a signal.

Other instrument systems use a mirror or plurality of mirrors to direct the image or signal to or from the instrument mounted in the vehicle. However, these systems tend to introduce distortions, especially at low angles, into the resulting image unless manufactured to extremely precise tolerances. These systems' complexity introduces a number of variables which complicate manufacture and may limit the accuracy of the instrument.

### SUMMARY OF THE INVENTION

The present invention addresses the above mentioned problems in the prior art and provides additional improvements and advantages that will be recognized by those skilled in the art upon review of the following Figures and description.

An object of the present invention is to provide an apparatus and method for directing an instrument at a target from a vehicle. Another object of the present invention is to provide an apparatus and method for directing an instrument mounted to a vehicle that is mounted substantially internal within the vehicle. Yet another object of the present invention is to reduce the size or eliminate the need for the external window or external turret used to protect the instrument on some vehicles. Still another object of the present invention is provide an apparatus which with control systems which is not prone to gimbal lock.

In one aspect, the present invention provides an apparatus for mounting an instrument. The mounting apparatus includes a first support having a first arched surface. The first arched surface can define a first arch having a constant radius of curvature or a variable radius of curvature. Accordingly, the first arch may be in the shape of a semicircle. The first support is hingedly secured to a mount to rotate about a first axis. The mount may be integral with a surface of a vehicle or may be a separate component which could be attached to a vehicle. An instrument mount is secured to the first arched surface to be movable between a plurality of points along the first arched surface. The instrument mount is generally configured to direct an instrument toward a center of the first arch. The instrument mount may include a friction reducing element to reduce friction as the instrument mount is moved along the first arched surface. The friction reducing surface may be a roller, a low friction material, or other friction reducing surface that will be recognized by those skilled in the art. The mounting apparatus can further include a first actuator connected to the first support to position the first support about the first axis. The mounting apparatus may also include a first linear actuator secured to the instrument mount to position the instrument mount along the first arched surface.

In another aspect, the present invention provides an apparatus for mounting an instrument having a first support and a second support. The first support again having a first arched surface. The first arched surface can define a first arch having a constant radius of curvature or a variable radius of curvature. Accordingly, the first arch may be in the shape of a semicircle. The first support is hingedly secured to a mount to rotate about a first axis. The second support having a second arched surface. The second arched surface can define a second arch having a constant radius of curvature or a variable radius of curvature. Accordingly, the second arch may be in the shape of a semicircle. The second support is hingedly secured to a mount to rotate about a second axis. The mount may be integral with a surface of a vehicle or may be a separate component which could be attached to a vehicle. An instrument mount is secured to the first arched surface and the second arched surface to be movable between a plurality of points along both of the first arched surface and the second arched surface. The instrument mount is generally configured to direct an instrument toward a center of the first arch and the second arch. The instrument mount may include a friction reducing element to reduce friction as the instrument mount is moved along the first arched surface and the second arched surface. The friction reducing surface may be a roller, a low friction material, or other friction reducing surface that will be recognized by those skilled in the art. The mounting apparatus can further include a first actuator connected to the first support to position the first support about the first axis. Similarly, the mounting apparatus can include a second actuator connected to the second support to position the second support about the second axis. Alternatively, the mounting apparatus may include a first linear actuator secured to the instrument mount to position the instrument mount about the second axis and may include a second linear actuator secured to the instrument mount to position the instrument mount about the first axis.

### BRIEF DESCRIPTION OF THE DRAWINGS

FIG. 1 illustrates a side view of a vehicle in partial cross-section including an apparatus for directing an instrument in accordance with the present invention;

FIG. 2 illustrates a perspective view of an embodiment of an apparatus for directing an instrument in accordance with the present invention;

FIG. 3 illustrates a side view of an embodiment of an apparatus for directing an instrument in accordance with the present invention;

FIG. 4 illustrates a top view of an embodiment of an apparatus for directing an instrument in accordance with the present invention;

FIG. 5 illustrates a perspective view of another embodiment of an apparatus for directing an instrument in accordance with the present invention;

FIG. 6 illustrates a perspective view of yet another embodiment of an apparatus for directing an instrument in accordance with the present invention; and

FIG. 7 illustrates a block diagram of an embodiment of a control system for an apparatus in accordance with the present invention.

### DETAILED DESCRIPTION OF THE INVENTION

The present invention provides an apparatus for mounting an instrument in a vehicle. The apparatus of the present invention could be used to mount an instrument in a wide variety of vehicles, including aircraft, spacecraft, ground vehicles, ships, and submarines. Furthermore, an apparatus in accordance with the present invention could be secured in an external pod or other modular elements that may be attached to the exterior of any one of the listed vehicles. For exemplary purposes and ease of description, the following description is generally directed to an apparatus and method for mounting an imaging instrument on an aircraft for ground surveillance.

Generally, an apparatus 10 in accordance with the present invention includes an instrument 12, an instrument mount 14, and at least a first support 16. Apparatus 10 typically mounts internally within a vehicle 100 and directs instrument 12 through a portal 102 in vehicle 100 toward a target or desired location. One or more supports may be hingedly secured to the vehicle 100. Instrument mount 14 is slidably attached to an arched portion of the one or more supports. Instrument 12 is secured to instrument mount 14. Instrument mount 14 is guided by at least a first support 16 through a range of motion which typically approximates a hemisphere (or other dome like shape) or portion thereof to direct instrument 12 toward a target.

Instrument 12 is typically configured to send or receive signals or to receive images. Instrument 12 includes a body defining a mounted portion 30 to instrument mount the instrument and a directed end 32. Directed end 32 of instrument 12 is the portion of the instrument which is directed toward the target location to send or receive signals or to receive images. Mounted portion 30 of instrument 12 is secured to instrument mount 14. Instrument 12 is typically secured to instrument mount 14 to maintain a constant position relative to instrument mount 14. Further, instrument 12 is secured to instrument mount 14 such that directed end 32 of instrument 12 is positioned inward toward the center of the hemisphere relative to mounted end 30. The movement of instrument mount 14 positions the mounted portion 30 of instrument 12 to align the directed end 32 of instrument 12 with a target. Thus, apparatus 10 can direct the directed end 32 of instrument 12 toward a target by moving the mounted end 30 to a particular set of coordinates on the hemisphere (or other shape) defined by the movement of instrument mount 14.

First support 16 functions to position instrument mount 14 within vehicle 100. Accordingly, first support 16 is configured to support the weight of at least instrument mount 14 and instrument 12 as the weight of instrument mount 14 and instrument 12 is shifted to various locations on first support 16. In some configurations having multiple supports, first support 16 may only need to be configured to support a portion of the weight of instrument mount 14 and instrument 12. First support 16 is movably secured to a vehicle to swing around a first axis 42. The swinging of first support 16 functions to position instrument mount 14 at various locations about first axis 42. As illustrated for exemplary purposes, first support 16 may be hinged to a base plate 90 which is secured to a vehicle 100 or may be hinged directly to vehicle 100.

First support 16 includes a first arched surface 40. First arched surface 40 is generally configured to receive instrument mount 14 and to facilitate the movement of instrument mount 14 along an arch defined by first arched surface 40. First arched surface 40 is typically in the shape of a semicircle but may include other fractional portions of a circle. Alternatively, first arch 42 may assume forms of other than circular origin such as a portion of a hyperbolic arch or other forms for orienting instrument mount 14. The combination of instrument mount 14 being movably secured to first arched surface 40 and the swinging rotation of the first arched surface 40 about the first axis 42 permits the positioning of instrument mount 14 at any coordinate on the surface defined by the rotation of first arched surface 40 about first axis 42.

In one aspect, the movement of first arched surface 40 may be controlled by a first actuator 60 which can controllably position first arched surface 40 at various positions along it range of motion about first axis 42. First actuator 60 may drive second support 18 in a variety of manners such as, for example, using gear, a worm drive, belt drive, chain drive, directly, a combination drive, or by other apparatus or systems that will be recognized by those skilled in the art upon review of the present disclosure. First actuator 60 is typically controlled by a controller 100, shown in FIG. 7, to position instrument mount 14 about first axis 42. The computer may communicate with the instrument 12 and motors through a set of cables 80 which connect the instrument to systems within vehicle 100.

A second support 18 may also be provided. Depending on the particular configuration, second support 18 may function to further support and position instrument mount 14 within vehicle 100. Accordingly, second support 18 is configured to support at least a portion of the weight of at least instrument mount 14 and instrument 12 as the weight of instrument mount 14 and instrument 12 is shifted to various locations on first support 16. Second support 18 is movably secured to a vehicle to swing around a second axis 46. First axis 42 and second axis 46 may be coplanar and may be perpendicular to one another. The swinging second support 18 functions to position instrument mount 14 at various locations about second axis 46. As illustrated for exemplary purposes, second support 18 may be hinged to a base plate 90 which is secured to a vehicle 100 or may be hinged directly to vehicle 100.

Second support 18 includes a second arched surface 44. Second arched surface 44 may also be generally configured to receive instrument mount 14 and to facilitate the movement of instrument mount 14 along an arch defined by second arched surface 44. Second arched surface 44 is typically in the shape of a semicircle but may include other fractional portions of a circle. Alternatively, second arch 44 may assume forms of other than circular origin such as a portion of a hyperbolic arch or other forms for orienting instrument mount 14. The combination of instrument mount 14 being movably secured to second arched surface 44 and the swinging rotation of the first arched surface 44 about the second axis 46 permits the positioning of instrument mount 14 at any coordinate on the surface defined by the rotation of second arched surface 44 about second axis 46.

In one aspect, the movement of second arched surface 44 may be controlled by a second actuator 64 which can controllably position second arched surface 44 at various positions along it range of motion about second axis 46. Second actuator 64 may drive second support 18 in a variety of manners such as, for example, using gear, a worm drive, belt drive, chain drive, directly, a combination drive, or by other apparatus or systems that will be recognized by those skilled in the art upon review of the present disclosure. Second actuator 64 is typically controlled by a controller 100, shown in FIG. 7, to position instrument mount 14 along second arched surface 44 as set forth in the examples below. The computer may communicate with the instrument 12 and motors through a set of cables 80 which connect the instrument to systems within vehicle 100.

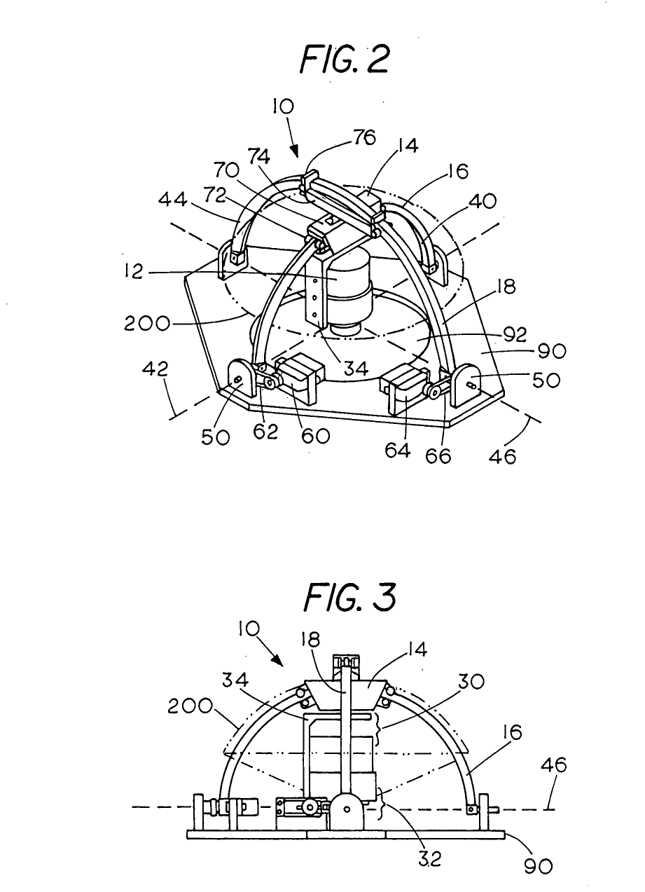

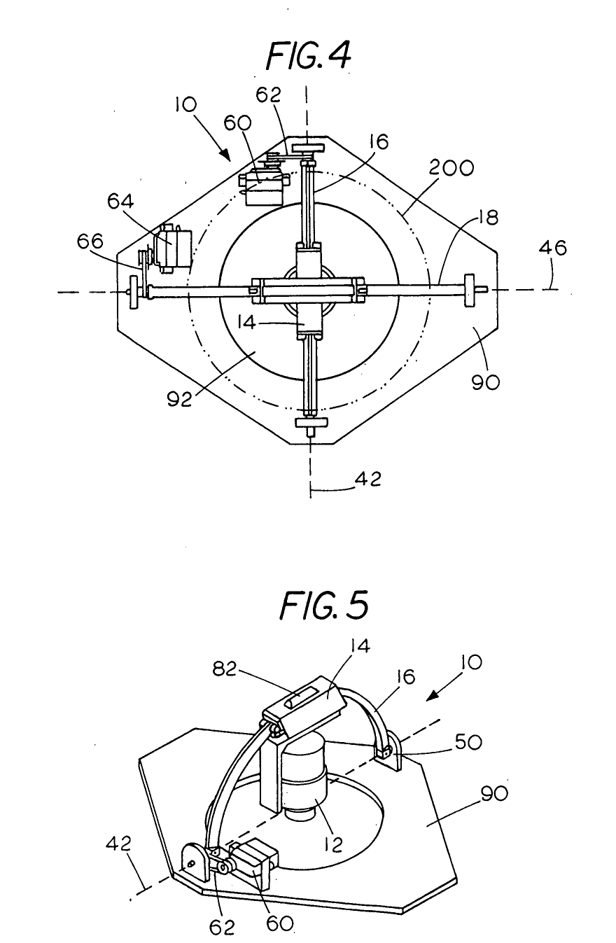

Instrument mount 14 is movably secured to at least one arched surface. The attachment of instrument mount 14 to the at least one arched surface is of sufficient strength to support the weight of both instrument mount 14 and instrument 12 at the various locations at which instrument mount 14 may be positioned about arched surface 40. Instrument mount 14 is generally configured to secure and direct instrument 12 as instrument mount 14 is positioned at various coordinates on the hemisphere, portion of a hemisphere, or other shape defined by the mount's range of movement. Accordingly, instrument mount 14 is generally configured to stably support and position the mass of instrument 12. Instrument mount 14 is secured to first arched surface 40 such that instrument mount 14 may be positioned at a plurality of points along the arch defined by first arched surface 40. Instrument mount 14 may include one or more friction reducing elements 72 such as, for example, rollers, ball bearings, low friction surfaces or other structures to reduce the frictional forces as instrument mount 14 is positioned at various coordinates. In one aspect, instrument mount 14 may be positioned along the first arched surface 40 by the mount's connection to a second support 18 having a second arched surface 44 to which instrument mount 14 is also movably secured as generally illustrated in the embodiments of FIGS. 2 to 4. In another aspect, instrument mount 14 may include a first linear actuator 82 to position instrument mount 14 along the first arched surface 40. In yet another aspect, instrument mount 14 may include a second linear actuator 82 to position instrument mount 14 along the second arched surface 44.

The mounted end 30 of instrument 12 is secured to instrument mount 14 to position the directed end 32 of instrument 12. Instrument 12 is secured to instrument mount 14 such that at least the directed end 32 of instrument 12 extends inward toward the center of first arched surface 40, generally toward the foci of the first arched surface 40, or otherwise generally into the first arched surface 40. As instrument mount 14 is moved through its range of motion, the longitudinal axis of instrument 12 can maintain a constant angle to a plane tangent to the shape defined by the movement of arched surface or arched surfaces which guide instrument mount 14. This constant angle is typically normal to the tangent plane. Essentially, instrument 12 can be supported by instrument mount 14 to form a cantilever along its longitudinal axis of instrument 12 to generally position the instrument's directed end 32 adjacent to portal 102 in a vehicle 100. In certain configurations, the position of directed end 32 remains substantially adjacent to the portal 102 the mounted end 30 is positioned by instrument mount 14 to direct the instrument.

When the instrument mount's range of movement defines in at least a portion of a hemisphere, instrument mount 14 will move at a fixed distance about a single point of rotation which will coincide with the center of the hemisphere. When the range of movement of instrument mount 14 is not hemispherical, the point of rotation may vary to some degree as instrument mount 14 is positioned at various locations in its range of movement. At any given location that instrument mount 14 may be positioned, the position of directed end 32 of instrument 12 relative to the point of rotation will depend on the length of the instrument relative to the radius of the hemisphere defined by the movement of instrument mount 14. In one aspect, directed end 32 of mounted instrument 12 will be remain inside the point of rotation as instrument mount 14 is positioned at various coordinates in its range of movement. In other aspects, directed end 32 of a mounted instrument 12 may extend to this point of rotation. In still other aspects, the directed end 32 of a mounted instrument 12 may extend beyond this point of rotation as instrument mount 14 is positioned at various coordinates in its range of movement.

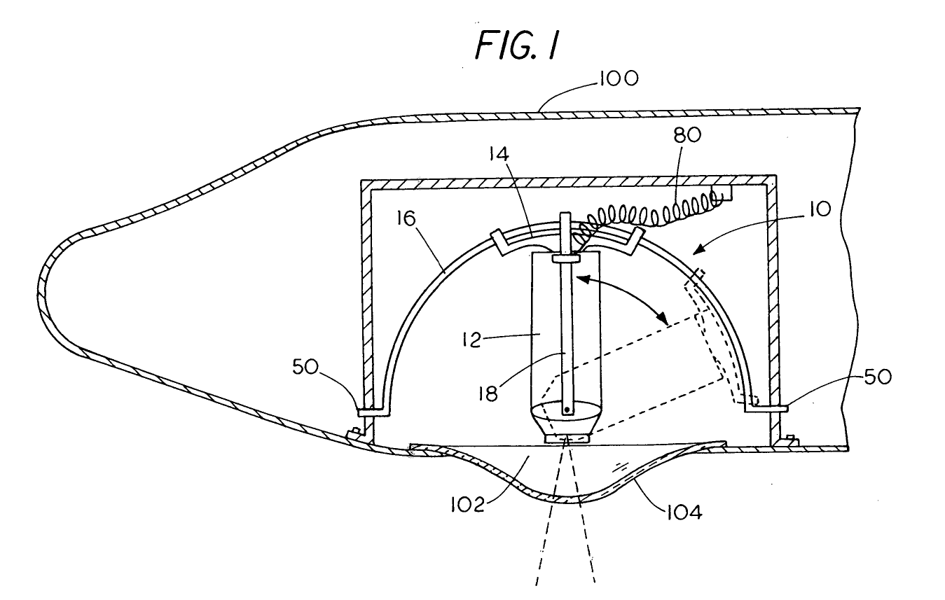

Similar embodiments of an apparatus 10 in accordance with the present invention are shown in FIGS. 1 to 4. As illustrated, apparatus 10 includes instrument 12 secured to an instrument mount 14, a first support 16, and a second support 18. The embodiment of FIG. 1 is operatively mounted for ground surveillance to a vehicle 100 which is illustrated for exemplary purposes as an unmanned aerial vehicle (UAV). Apparatus 10 is positioned in vehicle 100 to direct an instrument 12 generally downward through a portal 102 toward a target or location. A window 104 is provided over portal 102 on the underside of vehicle 100 to protect instrument 12 and to smooth airflow over the surface of vehicle 100. Window 104 is illustrated for exemplary purposes with some curvature to minimize variations in the distortion of an image received by instrument 12.

As illustrated in FIG. 1, first support 16 and second support 18 are secured by mounts 50 which are integral or otherwise attached to the fuselage of vehicle 100. Alternatively, mounts 50 may be integral with or attached to a base 90, as shown in FIGS. 2 to 4, which is secured to vehicle 100. Further, mounts 50 may be particularly described herein as first mount 50 and second mount 50 relative to being secured to first support 16 and second support 18, respectively. When mounted in a base 90, the directed end 32 of instrument 12 is typically positioned such that a sensing structure or emitting structure at the directed end is directed through an orifice 92 in the base 90. First support 16 and second support 18 are illustrated as having a similar semicircular configuration for exemplary purposes substantially differing only in their radii for exemplary purposes. Further, first support 16 and second support 18 are illustrated as having a triangular cross section for exemplary purposes. As illustrated, each of the three exterior surfaces of the triangular cross-section may be considered a first arched surface 40 and a second arched surface 44 for first support 16 and second support 18, respectively. In essence, the embodiments illustrated in FIGS. 1 to 4 present a first support 16 and a second support 18 in which the first arched surface 40 and the second arched surface 44 are substantially coextensive with the entire exterior surface of the respective first support 16 and second support 18. In other embodiments, the first arched surface 40 and the second arched surface 44 may be limited to distinct regions or portions of first support 16 and a second support 18, respectively.

First support 16 rotates about a first axis 42 to position instrument mount 14 along second arched surface 44. A first actuator 60 controlled by a controller 100, shown in FIG. 7, positions first support 16 about first axis 42. For exemplary purposes, actuator 60 is illustrated as positioning first support 16 around first axis 42 with a belt 62.

Second support 18 rotates about a second axis 46 to position instrument mount 14 along first arched surface 40. A second actuator 64 controlled by a controller 100, shown in FIG. 7, positions first support 16 about first axis 42. For exemplary purposes, second actuator 64 is illustrated as positioning second support 18 around second axis 46 with a belt 66.

Instrument mount 14 is illustrated in FIGS. 2 to 4 with a composite structure for exemplary purposes. As illustrated, instrument mount 14 includes a first member 70 slidably secured to first arched surface 40 and a second member 74 slidably secured to second arched surface 44. First member 70 includes a first friction reducing element 72 illustrated as a plurality of rollers to minimize the frictional forces resulting from the first element's contact with the first arched surface 40 for exemplary purposes. Second member 74 includes a second friction reducing element 76 illustrated as a plurality of rollers to minimize the frictional forces resulting from the second element's contact with the second arched surface 44 for exemplary purposes. First member 70 and second member 74 are securedly attached to one another to form instrument mount 14. First member 70 and second member 74 may be secured to one another in a manner to permit the rotation of first member 70 and second member 74 relative to one another. In other embodiments, instrument mount 14 may be formed from a single piece of material or may be formed from more than two components.

Instrument 12 includes a mounted end 30 and a directed end 32. Mounted end 30 is secured proximate to instrument mount 14. As illustrated in FIGS. 2 to 4, instrument 12 is secured to instrument mount 14 by a bracket 34 for exemplary purposes. In other embodiments, the instrument 34 may be directly secured to instrument mount 14. Directed end 32 extends away from instrument mount 14 toward the center of the portion of the hemisphere defined by the movement of instrument mount 14 along first arched surface 40 and seconded arched surface 44. Furthermore, the directed end 32 of instrument 12 is typically configured such that a sensing structure or emitting structure at the directed end is generally directed toward the center of the rotation of instrument mount 12 about first axis 42 and second axis 46 regardless of the position of the mount. In some embodiments, directed end 32 of instrument 12 may extend beyond the center of the rotation of instrument mount 12 about first axis 42 and second axis 46.

In operation, second actuator 64 positions second support about second axis 46. This movement of second support 18 slidably positions instrument mount 14 on first arched surface 40. First actuator 60 positions first support about first axis 42. This movement of first support 16 slidably positions instrument mount 14 on second arched surface 44. The combination of the mount's positioning about first arched surface 40 and second arched surface 44 permits instrument mount 14 to direct instrument 12 at a desired target.

Another embodiment of an apparatus 10 in accordance with the present invention is illustrated in FIG. 5. Apparatus 10 of FIG. 5 generally includes a first support 16, an instrument mount 14, a mount drive unit 26, and an instrument 12. First support 16 is secured by mounts 50 to a base 90 or other mounts 50 which are otherwise secured to vehicle 100. When mounted in a base 90, the directed end 32 of instrument 12 is typically positioned such that a sensing structure or emitting structure at the directed end is directed through an orifice 92 in the base 90. First arched surface 40 is illustrated as having a semicircular configuration for exemplary. Further, first support 16 is illustrated as having a rectangular cross section for exemplary purposes. As illustrated, each of the four exterior surfaces of the triangular cross-section may be considered a first arched surface 40 of first support 16. In essence, the embodiment illustrated in FIG. 5 presents a first support 16 in which the first arched surface 40 is substantially coextensive with the entire exterior surface of the first support 16. In other embodiments, the first arched surface 40 may be limited to a distinct region or portion of first support 16.

First support 16 rotates about a first axis 42 to position instrument mount 14 around first axis 42. A first actuator 60 controlled by a controller 100, shown in FIG. 7, positions first support 16 about first axis 42. For exemplary purposes, actuator 60 is illustrated as positioning first support 16 around axis 42 with a belt 62 driven by motor 60.

Instrument mount 14 is fixedly secured to the mounted end 30 of instrument 12. Instrument mount 14 is also movably secured to first support 16 to permit positioning along the first arched surface 40. As illustrated in FIG. 5, a first linear actuator 82 is secured to instrument mount 14. First linear actuator 82 can include a motor or other actuator operatively connected to first support 16 to facilitate the movement or positioning of instrument mount 14 on first arched surface 40. To drive instrument mount 14, first linear actuator 82 may for example include a drive wheel communicating with the first arched surface 40, or a cog or worm gear which receives a series of teeth on the first support 16. First linear actuator 82 is typically controlled by a controller 100, shown in FIG. 7, to position instrument mount 14 about first ached surface 40.

In one aspect, instrument mount 14 may be positioned along the first arch by a linear motor. In this aspect, first linear actuator 82 may function as the rotor of linear motor while the first arched surface 40 operates as the stator of the linear motor. To function as linear motor, first linear actuator 82 may include a magnet and first arched surface 40 may include a plurality of wound electrical elements. The wound electrical elements may be embedded in the material of first arched surface 40. The wound electrical elements are used to generate a magnetic field by passing an electric current through them. By controlling the magnetic field, instrument mount 14 may be precisely positioned along first arched surface 40.

In operation, first linear actuator 82 positions instrument mount 14 on first arched surface 40. First actuator 60 positions instrument mount 14 about axis 42 by positioning first arched surface 40 about first axis 42. The combination of positioning instrument mount 14 on arched surface 40 and positioning instrument mount 14 about first axis 42 permits instrument mount 14 to direct instrument 12 at a desired target.

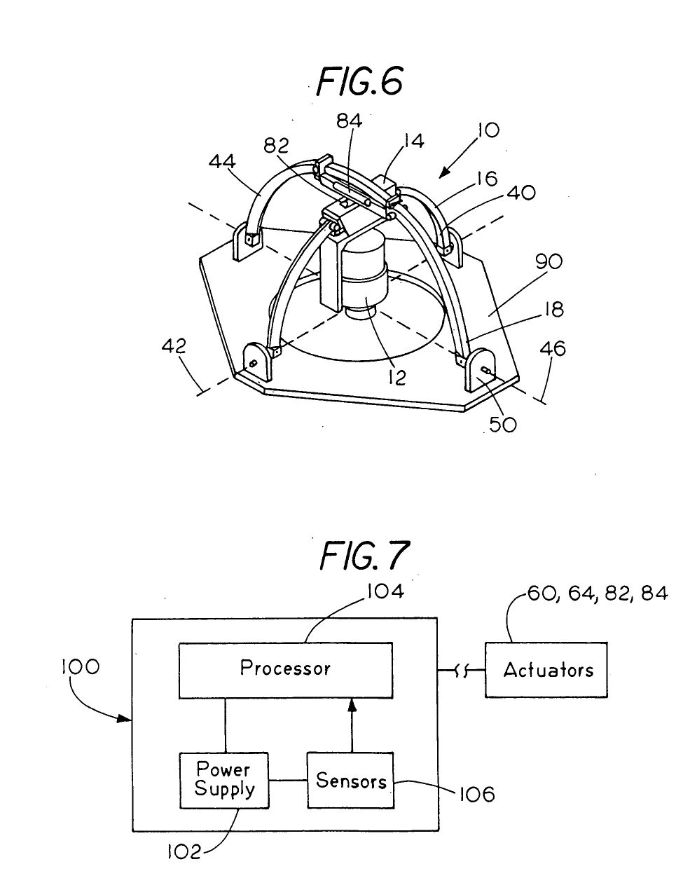

Yet another embodiment of an apparatus 10 in accordance with the present invention is shown in FIG. 6. As illustrated, apparatus 10 includes instrument 12 secured to an instrument mount 14, a first support 16, and a second support 18. First support 16 and second support 18 are illustrated as hinged to mounts 50 which are integral with a base 90, for exemplary purposes. Again, mounts 50 may be particularly described herein as first mount 50 and second mount 50 relative to being secured to first support 16 and second support 18, respectively. First support 16 and second support 18 are illustrated as having a similar semicircular configuration for exemplary purposes substantially differing only in their radii for exemplary purposes. Further, first support 16 and second support 18 are illustrated as having a triangular cross section with the apexes of the triangles directed toward one another for exemplary purposes. As illustrated, each of the three exterior surfaces of the triangular cross-section may be considered a first arched surface 40 and a second arched surface 44 for first support 16 and second support 18, respectively. Like another illustrated embodiment, the embodiment illustrated in FIG. 6 includes a first support 16 and a second support 18 in which the first arched surface 40 and the second arched surface 44 are substantially coextensive with the entire exterior surface of the respective first support 16 and second support 18. In other embodiments, the first arched surface 40 and the second arched surface 44 may be limited to distinct regions or portions of first support 16 and a second support 18, respectively.

Instrument mount 14 is movably secured to first support 16 to permit positioning of instrument mount 14 along the first arched surface 40. As illustrated in FIG. 6, a first linear actuator 82 and a second linear actuator 84 are secured to instrument mount 14. First linear actuator 82 can include a motor or other actuator operatively connected to first support 16 to permit the movement or positioning of instrument mount 14 along first arched surface 40. Second linear actuator 84 can include a motor or other actuator operatively connected to second support 18 to facilitate the movement or positioning of instrument mount 14 along second arched surface 44. To drive instrument mount 14, first linear actuator 82 and second linear actuator 84 may for example include a drive wheel communicating with the first arched surface 40, or a cog or worm gear which receives a series of teeth on the first support 16. First linear actuator 82 and second linear actuator 84 are typically controlled by a controller 100, shown in FIG. 7, to position instrument mount 14 about first ached surface 40.

In one aspect, instrument mount 14 may be positioned by linear motors. In this aspect, first linear actuator 82 and second linear actuator 84 may function as the rotors of linear motors while the first arched surface 40 and the second arched surface 44 operate as the stators of the linear motors. To function as linear motors, first linear actuator 82 and second linear actuator 84 may include a magnet and first arched surface 40 and the second arched surface 44 may include a plurality of wound electrical elements. The wound electrical element may be embedded in the material of first arched surface 40 and the second arched surface 44. The wound electrical elements are used to generate a magnetic field by passing an electric current through them. By controlling the magnetic fields, instrument mount 14 may be precisely positioned along both of first arched surface 40 and second arched surface 44.

Instrument 12 includes a mounted end 30 and a directed end 32. Mounted end 30 is secured proximate to instrument mount 14. As illustrated in FIG. 6, instrument 12 is secured to instrument mount 14 by a bracket 34 for exemplary purposes. In other embodiments, the instrument 34 may be directly secured to instrument mount 14. Directed end 32 extends away from instrument mount 14 toward the center of the portion of the hemisphere defined by the movement of instrument mount 14 along first arched surface 40 and seconded arched surface 44. Furthermore, the directed end 32 of instrument 12 is typically configured such that a sensing structure or emitting structure at the directed end is generally directed toward the center of the rotation of instrument mount 12 about first axis 42 and second axis 46 regardless of the position of the mount. In some embodiments, directed end 32 of instrument 12 may extend beyond the center of the rotation of instrument mount 12 about first axis 42 and second axis 46.

In operation, first linear actuator 82 positions instrument mount 14 on first arched surface 40. Second linear actuator 84 positions instrument mount 14 on second arched surface 44. The combination of the mount's positioning about first arched surface 40 and second arched surface 44 permits instrument mount 14 to direct instrument 12 at a desired target.

FIG. 7 illustrates an exemplary embodiment of a controller 100 to position and control the movement of instrument mount 14. As illustrated, controller 100 includes a power supply 102, a processor 104 and one or more sensors 106. Power supply may provide power to processor 104 and sensor 106 as well as other components of the mounting apparatus 10. Processor 104 is typically a microprocessor. In one aspect, the microprocessor can control the position of instrument mount 14 to direct instrument 12 at a target using an algorithm based on two pi steradian movement. Processor 104 controls the actuators to position instrument mount 14. Sensors 106 can determine the position of instrument mount 14, the position of first arched surface 40, the position of seconded arched surface 44, and/or the position of the actuators and provide a signal to the microprocessor indicative of these one or more positions. Processor 104 may use these signals to adjust the position of instrument mount 14.

The present invention is not intended to be limited to the particular embodiments disclosed in this description. Upon review of the description and figures, it will be apparent to those skilled in the art that various modifications and variations can be made to the structure and method of the present invention without departing from the scope or spirit of the invention. In view of the foregoing, it is intended that the invention cover modifications and variations to the described embodiments that come within the scope of the claims and their equivalents.

What is claimed is:

1. A mounting apparatus, comprising:
a first support hingedly secured to a mount to rotate about a first axis and having a first arched surface with the first arched surface defining a first arch; and
an instrument mount configured to direct an instrument toward a center of the first arch and movably secured to the first arched surface to position the instrument mount at a plurality of points along the first arched surface.

2. A mounting apparatus, as in claim 1, further comprising a first actuator connected to the first support to position the first support about the first axis.

3. A mounting apparatus, as in claim 1, further comprising a first linear actuator secured to the instrument mount to position the instrument mount along the first arched surface.

4. A mounting apparatus, as in claim 1, wherein the first arch comprises a semicircle.

5. A mounting apparatus, as in claim 1, further comprising a first friction reducing element secured to the instrument mount.

6. A mounting apparatus, as in claim 5, wherein the first friction reducing element secured to the instrument mount comprises a roller.

7. A mounting apparatus, comprising:
a first support hingedly secured to a first mount to rotate about a first axis and including a first arched surface with the first arched surface defining a first arch;
a second support hingedly secured to a second mount to rotate about a second axis and including a second arched surface with the second arched surface defining a second arch; and
a instrument mount configured to direct an instrument toward a center of the first arch and second arch and movably secured to the first arched surface and the second arched surface wherein the instrument mount may be positioned at a plurality of points along either of the first arched surface and the second arched surface.

8. A mounting apparatus, as in claim 7, further comprising a first actuator connected to the first support to position the first support about the first axis.

9. A mounting apparatus, as in claim 8, further comprising a second actuator connected to the second support to position the second support about the second axis.

10. A mounting apparatus, as in claim 8, further comprising a first linear actuator secured to the instrument mount to position the second support about the second axis.

11. A mounting apparatus, as in claim 7, wherein the first arch comprises a semicircle.

12. A mounting apparatus, as in claim 7, further comprising a first friction reducing element secured to the mount.

13. A mounting apparatus, as in claim 12, wherein the first friction reducing element secured to the instrument mount comprises a roller.

14. A mounting apparatus, as in claim 7, further comprising a first linear actuator secured to the instrument mount to position the instrument mount along the first arched surface.

15. A mounting apparatus, as in claim 14, further comprising a second linear actuator secured to the instrument mount to position the instrument mount along the second arched surface.
